(19) United States
(12) Patent Application Publication
(10) Pub. No.: US 2007/0083375 A1
(43) Pub. Date: Apr. 12, 2007

(54) METHOD AND SYSTEM FOR TEMPLATE INQUIRY DIALOGUE SYSTEM

(75) Inventors: Yun-Wen Lee, Taoyuan Hsien (TW); Chien-Chou Hung, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/469,056

(22) Filed: Aug. 31, 2006

(30) Foreign Application Priority Data
Sep. 2, 2005 (TW) 094130227

(51) Int. Cl. G10L 21/00

(52) U.S. Cl. 704/275

(57) ABSTRACT

A method for recognizing a voice is provided. The method includes steps of (a) displaying a substitute choice and a hint sentence containing a suggested choice as a reference for a user, (b) receiving the voice to be recognized from the user, (c) conducting a search in a database to give a result according to the voice, and (d) repeating steps (a)-(c) to narrow down a search range until a desirable result is obtained.

### FIELD OF THE INVENTION

The present invention relates to a method and system for speech recognition. More particularly, the present invention relates to a method and system for speech recognition which display a hint sentence on the display.

### BACKGROUND OF THE INVENTION

At present most dialogue systems work on a platform of telephone, and there are few, such as the entertainment center, equipped with displays, which give a voice response to simulate the human dialogue. There is a disadvantage that even though the voice hint guides a user to give an answer as relevant as possible, it is still slower and less clear than the answer given by reading. If there are not sufficient hints for the dialogue, what a user said usually fails to be covered in the pre-collected knowledge of the computer. Consequently, the computer will hardly understand the human speech. It therefore consumes a lot of time, labor, and cost to collect the domain knowledge trying to cover the majority of the possible questions from the users and the way of questioning and answering. However, due to the wide variety ways to question and answer, a certain percentage of the domain knowledge usually fail to be collected even after a long period of time.

Generally, there is another method to build up a dialogue system with fast speed by keyword spotting. That is, the use of the confidence of the input voice is evaluated to eliminate the words not covered in the system, and then a Natural Language Understand (NLU) module is used to conduct a more robust comprehension on the voice. To sum up, the system of keyword spotting giving a keyword string seems to be applicable to the natural language input, but keyword spotting thereof without the limitation on a complete sentence grammar will not work as perfectly as the recognition with the auxiliary limitation on a complete sentence grammar.

At present the voice controlled computer software such as “ViaVoice on OS2” for business use, providing all keywords recognizable on a display, operates in a way of recognizing a single word. Like the entertainment center, the system of a natural language input provides recognizable keywords such as the title of a song, which is recognized by keyword spotting. There is not yet a system hinting a complete sentence which the voice recognition cooperating with the NLU voice recognition depends on at this moment.

After a long intensive series of experiments and researches, the inventors finally sets forth such a method and system for the template inquiry dialogue system, which may effectively overcome the demerits existing in the prior art.

### SUMMARY OF THE INVENTION

It is a first aspect of the present invention to provide a method and system for recognizing voice, wherein a hint sentence is displayed on the display to give the user an idea on what to say.

It is a second aspect of the present invention to provide a method and system for recognizing voice, containing three choice states for the user to inquire and confirm.

It is a third aspect of the present invention to provide a method for recognizing a voice. The method includes steps of (a) displaying a substitute choice and a hint sentence containing a suggested choice as a reference for a user, (b) receiving the voice to be recognized from the user, (c) conducting a search in a database to give a result according to the voice, and (d) repeating steps (a)-(c) to narrow down a search range until a desirable result is obtained.

Preferably, the hint sentence and the substitute choice are displayed on a display.

Preferably, the step (a) further comprises a step of displaying a first choice state, a second choice state, and a third choice state.

Preferably, the first choice state is a state of “yes”.

Preferably, the second choice state is a state of “no”.

Preferably, the third choice state is a state of “don't-care”.

Preferably, the database is established by (a) preparing a domain database for a product, (b) defining a plurality of choices relating to the product, (c) tagging each of the plurality of choices with all possible descriptions, (d) defining a classification and a hierarchy among the plurality of choices, (e) defining a conflict relationship among the plurality of choices, (f) defining a quantifier for the product, (g) defining a specific hint sentence, (h) defining a criterion for narrowing down and widening up an inquiring range, and (i) establishing a grammar database, a domain knowledge database, and a conflict information database.

Preferably, the plurality choices contain the suggested choices and the substitute choices.

Preferably, the database is a specific domain database.

Preferably, the step (d) further includes steps of repeating steps (a)-(c) to widen up the search range until the desirable result is obtained.

It is a fourth aspect of the present invention to provide a voice recognizing system giving an inquiry result based on a voice input. The voice recognizing system includes a specific domain database, and an inquiry dialogue system comprising a voice recognizer recognizing the voice input, a language understanding unit using results of the voice recognizer and understanding the voice input to give a semantic result, and an inquiry dialogue controller communicating with the language understanding unit and conducting a dialogue control and an inquiry according to the semantic result to give a hint sentence and the inquiry result.

Preferably, the specific domain database comprises a grammar database storing a plurality of words and a plurality of grammars, thereby the voice recognizer and the language understanding unit connected thereto recognizing and analyzing the voice input, a domain database connected to the inquiry dialogue controller and storing a plurality of data relating to a product, a domain knowledge database connected to the inquiry dialogue controller and storing a domain knowledge relating to the product, and a conflict information database connected to the inquiry dialogue controller and managing to store a conflict relationship among choices for the product.

Preferably, the inquiry result is derived from the plurality of data.

Preferably, a text-to-speech module is connected to the inquiry dialogue controller.

Preferably, a voice output device is connected to the text-to-speech module for giving a voice output.

Preferably, a voice input device is connected to the voice recognizer for receiving the voice input therewith.

Preferably, the voice input device is a microphone.

Preferably, a display is connected to the inquiry dialogue controller for displaying the hint sentence and the inquiry result.

It is a fifth aspect of the present invention to provide a voice recognition system for giving an inquiry result based on a voice input. The voice recognition system comprises an inquiry dialogue system, and a specific domain database comprising a grammar database storing a plurality of words and a plurality of grammars, a domain database storing a plurality of data relating to a product, a domain knowledge database storing a domain knowledge relating to the product, and a conflict information database managing to store a conflict relationship among choices for the product.

It is a sixth aspect of the present invention to provide a method for recognizing a voice of a user. The method includes steps of (a) displaying a substitute choice, a choice state, and a hint sentence including at least a suggested choice as a reference for the user, (b) receiving the voice to be recognized, (c) conducting a search in a database according to the voice to give a result of the search, and (d) repeating steps (a)-(c) to narrow down a search range until a desirable result of the search is acquired.

Preferably, the hint sentence, the substitute choice, and the choice state are displayed on a display.

Preferably, the choice state at least has a first choice state, a second choice state, and a third choice state.

Preferably, the first choice state is a state of “yes”.

Preferably, the second choice state is a state of “no”.

Preferably, the third choice state is a state of “don't-care”.

Preferably, wherein the step (d) further includes repeating steps (a)-(c) to widen up the search range until the desirable result of the search is obtained.

It is a seventh aspect of the present invention to provide a method for establishing a database in a specific domain. The method includes steps of (a) preparing a domain database for a product, (b) defining a plurality of choices relating to the product, (c) defining a hint sentence, (d) defining a criterion for changing an inquiring range for the product, and (e) establishing a grammar database, a domain knowledge database, and a conflict information database.

Preferably, the method further comprises a step of tagging each of the plurality of choices with all possible descriptions.

Preferably, the method further comprises a step of defining a classification and a hierarchy for the plurality of choices.

Preferably, the method further comprises a step of defining a conflict relation for each of the plurality of choices.

Preferably, the method further comprises a step of defining a quantifier for the product

Other objects, advantages and efficacies of the present invention will be described in detail below taken from the preferred embodiments with reference to the accompanying drawings, in which:

### BRIEF DESCRIPTION OF THE DRAWINGS

FIG. 1 is a schematic diagram of the voice recognition system according to a preferred embodiment of the present invention;

FIG. 2 is a schematic diagram showing a flow chart of the inquiry dialogue controller;

FIG. 3 is a schematic diagram showing the procedure for establishing the specific domain database; and

FIGS. 4(a)-(d) are schematic diagrams showing the practical inquiry process according to a preferred embodiment of the present invention.

### DETAILED DESCRIPTION OF THE PREFERRED EMBODIMENT

To overcome the drawbacks of the prior art, the present invention intends to establish a dialogue system cooperating with different databases to form a new dialogue system for conducting a search. Traditionally, it consumes a great deal of time, cost, and labor to collect the domain knowledge in the relevant field to establish a dialogue system to cover a majority of possible questions from the user and the way of questioning and answering, and therefore the development and application of the dialogue system are considerably confined. Accordingly, the present invention proposes that in the condition that a display is available for the user, all hint sentences relating to possible input sentences from the user are displayed thereon in each dialogue state, so as to avoid the situation when the system fails to understand the input words and grammar because the user does not know how to give a question.

In the present invention, by means of hint sentences and keywords from the display, a range of input from the user is effectively confined so that the user is guided to establish the domain knowledge, such as the information of a database, quantifier, and choice conflict relationship, in a specific domain database which is independent of the inquiry system. Accordingly, a new dialogue system of a domain is established quickly by means of the inquiry system with different specific domain databases for different fields.

Furthermore, both the inquiry systems of GUI and VUI have only choices states of “checked” and “not checked”. For example, when the user checks the check box of GUI for a bluetooth feature, the bluetooth feature is desired; otherwise, it is not cared. In the present invention, a third choice state of “no” is proposed. For example, “no” for Motorola means the user wants brands excluding Motorola.

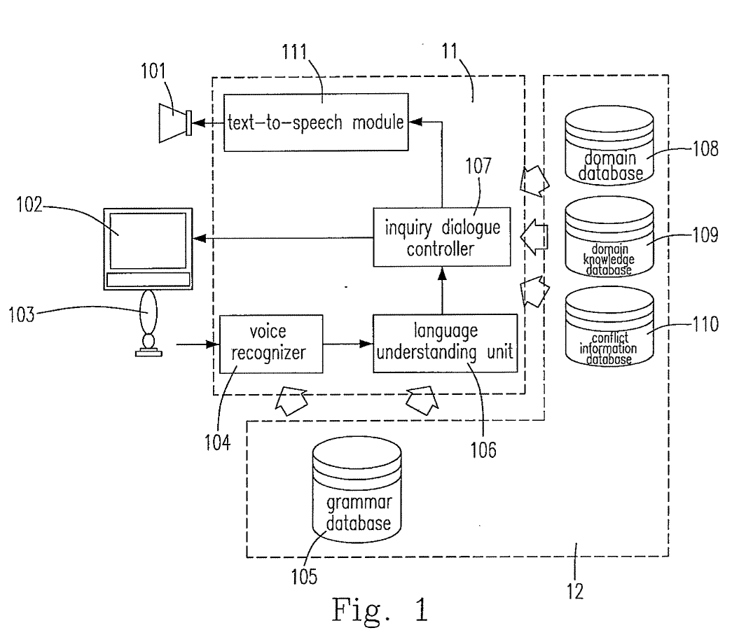

Referring to FIG. 1, which is a schematic diagram of the voice recognition system according to a preferred embodiment of the present invention. The voice recognition system includes an inquiry dialogue system 11 and a specific domain database 12, wherein the inquiry dialogue system 11 contains a voice recognizer 104, a language understanding unit 106, an inquiry dialogue controller 107, and a text-to-speech module 111. The specific domain database 12 contains a grammar database 105, a domain database 108, a domain knowledge database 109, and a conflict information database 110.

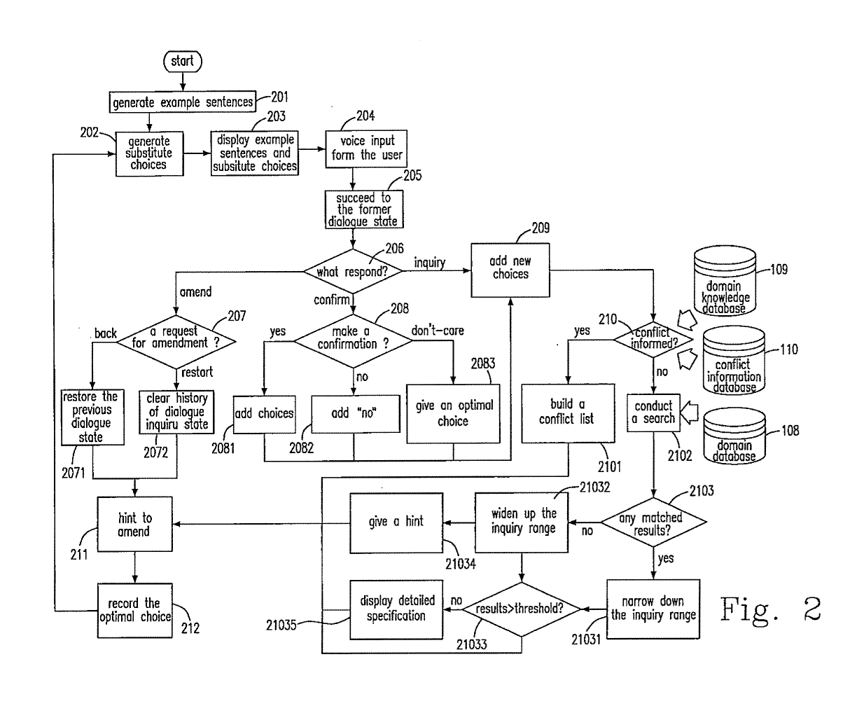

When the voice recognition system starts, the inquiry dialogue controller 107, a flow chart of which is illustrated in FIG. 2, will guide the user by inquiry sentences through example sentences from the domain knowledge database 109 (step 201), and generate all substitute choices for the example sentences (step 202), which are displayed on the display 102 to guide the user on how to conduct an inquiry (step 203). Subsequently, by voice input from the user (step 204) to the voice input device 103 (a microphone, for example), an inquiry sentence is input, which is recognized and analyzed by the voice recognizer 104 and the language understanding unit 106 according to the words and grammar defined by the grammar database 105. An analyzed semantic result is delivered to the inquiry dialogue controller 107 by the language understanding unit 106 to conduct a dialogue control and guide the user for the following inquiry.

The inquiry dialogue controller 107 succeeds to the former dialogue state (step 205) and then responds based on the result from the language understanding unit 106 (step 206). New input choices and former dialogue choices are integrated to find conflicts thereamong according to the conflict information of the conflict information database 110 (step 209).

When conflicts appear in the previous step (step 210), the voice recognition system will keep the conflict choices in a conflict list, and the user can make a confirmation of preservation or delete new choices of input according to the conflict list. A confirmation of preservation will keep the new choices of input to remove other conflict choices on the conflict list. If the new choices of input are not on the conflict list, the conflict among the choices would be determined according to the domain knowledge database 109 and the conflict information database 110. If a conflict happens, the conflict could be ignored according to the definition thereof in the conflict information database 110, which requires no confirmation from the user, and the new choices would be substituted for old ones. Otherwise, a new conflict list is built to record the conflict, and hint sentences of choices are generated for the user to exclude conflicts (step 2101). The current accumulated choice list would conduct a search in the domain database 108 when there are no other conflicts in choices (step 2102).

For example, if two brands Nokia and Motorola are chosen in order, the step 210 would inform a conflict according to the conflict information database 110, wherein an inquiry of brand name change is customary in mobile phone domain. Therefore, brand replacement needs no confirmation. Subsequently, Motorola is substituted for Nokia in step 210 without a confirmation from the user, and then the step 2102 is executed to conduct a search in the domain database 108. If the choices of conflict do not include both a new one and an old one, and are prohibited in the conflict information database 110, the step 2101 would build a conflict list of Nokia and Motorola for a record thereof to give such a hint sentence of choice as “I want a Nokia mobile phone” to guide the user to give a confirmation in the next sentence input to get rid of conflicts.

When the inquiry is as input as “I want a Nokia mobile phone”, and the system has a conflict list about Nokia conflicting with Motorola, the input of Nokia would replace Motorola due to the conflict therebetween from the conflict list. If the conflict list is unavailable, system will use information from domain knowledge database 109 and the conflict database 110 to decide if the step 2101 or the step 2102 is to be executed next.

According to the step 2102, if in the step 2103 no matched results are found, thereby implying we need to relax criterions, e.g., to decrease choices of inquiry, the step 21032 executes practical removal of choices to give matched results by a search in the domain database 108 to suggest a hint sentence, and guide the user to widen up the limitation on the inquiry. More specifically, suggested choices could be ranked according to the criterion defined in the domain knowledge database 109, and a best choice through widen up regulations is suggested by the system for the user to directly reply with “yes/no/don't-care” to a question. For example, the system may ask “do you accept mobile phones excluding Nokia?”, and the hint sentence, “yes/no/don't-care”, is given in the step 21034 for the user to respond thereto. On the other hand, if the inquiry in the step 2102 affords to give matched results more than one, the system would utilize the choices not yet considered to narrow down the range of the inquiry in the step 21031, wherein the given results would be compared with each other for distinctions thereamong to give a hint sentence thereby to guide the user.

Similarly, in the step 21031, the narrowed down choices through optimized regulations are ranked according to the domain knowledge database 109 to give best choice for the user to directly answer with “yes/no/don't-care”. For example, the system may ask: “do you need a mobile phone with a bluetooth feature?”, and give the user a hint, “yes/no/don't-care”, in the step 21034.

Because a screen size of a display 102 is limited and most users are not interested in a large amount of results, the step 21033 would decide whether the detailed result list of the inquiry is displayed in the step 21035 according to the threshold defined by the domain knowledge database 109. The step 211 also hints the user how to amend the former false state, for example, restart/back, due to the potential errors from the voice recognition.

The step 207 distinguishes “restart” and “back” from a request of the user for amendments. In the step 2072, the history of the inquiry dialogue state is cleared for the request to restart a new inquiry dialogue. If the user wants to correct the input error in the last inquiry, in the step 2071, the system would go back to an inquiry dialogue state before the last one kept in the step 212.

Typically, the system is composed of states, “check” and “not checked”, but no option of “no” is provided, wherein “not checked” means “don't-care”. For example, if the user does not need a camera feature, the system can give a sentence, “I do not need camera feature”, as a choice, wherein no camera feature is added to the choice list. Likewise, the system may ask “do you need a phone with a camera?”, wherein a confirmation thereof is made in the step 208, and a response of “no” would also add no camera feature to the choice list in the step 2082. Similar to the step 2082, the step 2081 adds confirmed choices by the user to the choice list, which are suggested in the steps 21031 and 21032. The choice conflict thereof is examined in the step 210 to decide whether to inquiry in the step 2102 or to deal with the conflict in the step 2101.

When the user considers the suggested choices in the steps 21031 or 21032 as “don't-care”, the step 2083 would pick up a best choice for the user as the steps 21031 and 21032 do. According to the choices of “don't-care”, suggested by the previous steps 21031 or 21032, the step 2083 gives an optimal choice based on the confirmed choice list to give a further suggested choice as the steps 21031 and 21032 do. Because of inevitable errors from the recognition or the user in a voice inquiry, the step 211 hints the user how to amend the failure in the previous sentence, wherein one of “restart” and “back” is available for the user in the present invention.

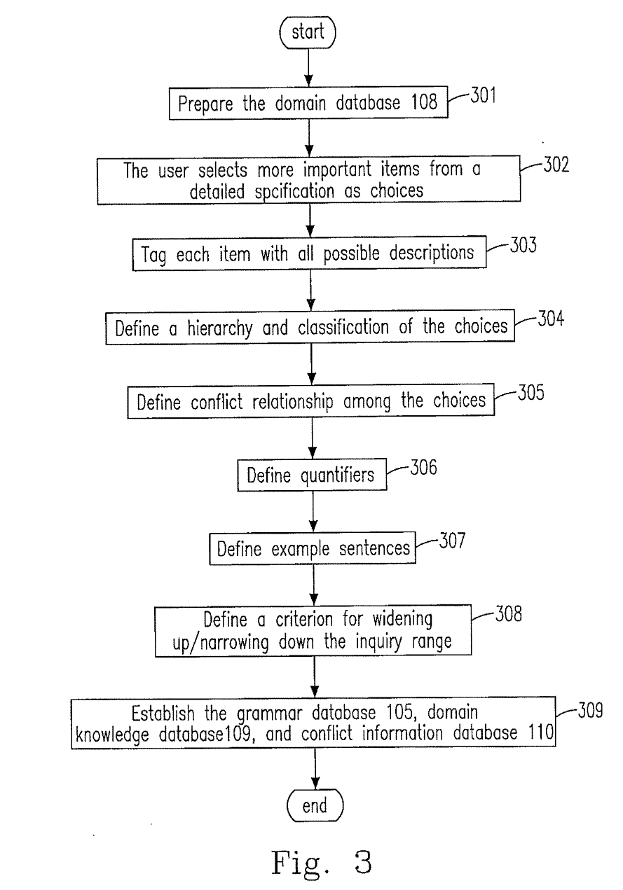

Additionally, a method for establishing the specific domain database 12 is proposed in the present invention as illustrated in FIG. 3, wherein such a method as Wizard is utilized to guide the user.

Firstly, the domain database 108 is prepared in the step 301, such as mobile phones, cars, or period pieces of the National Palace Museum. Take the mobile phones for example, regarding the corresponding domain database, each detailed specification thereof is necessarily prepared along with the corresponding figures available. Subsequently, the system would list a detailed specification for the user to select those more important items as choices for the system in the step 302. Then, each listed item is tagged with all possible descriptions thereon in the step 303. Take ASUS for example, for people customary to Chinese, pronunciations thereof in English and Mandarin could be tagged with the corresponding descriptions. Another example is multi-pronunciation. For some words, there are several different pronunciations, WiFi, for example. Accordingly, it is necessary to define all customary pronunciations for the users in the step 303.

Secondly, a classification and hierarchy of the choices are defined in the step 304, wherein resolutions of one and two million pixels belong to a photographing function. It is also understood that choices of resolutions of one and two million pixels are rejected in case the user chooses “no” to the camera feature under a well-defined hierarchy.

Thirdly, since each mobile phone has only one brand, the conflict relationships among the choices, such as conflicts among each brand, are defined in the step 305, wherein a compound brand like Sony-Ericsson is still a brand rather than two. Accordingly, an exclusive relationship regarding the brands is defined. There are further conflict relationships specifically defined based on the domain knowledge, such as the conflict between PHS and CDMA which does not result from a structure thereof.

Quantifiers, as affected by unit terms in Mandarin or gender influences in Spanish, for mobile phones or cars for example are defined to be displayed or asked by the system in the step 306 to compose example sentences provided by the system in the step 307 to guide the user.

For example, an inquiry hint sentence could be “I want a Nokia mobile phone with bluetooth feature.”, a widen up hint sentence could be “Do you accept a mobile phone not produced by Nokia?”, a widen up confirmation hint sentence could be “yes/no/don't-care”, a narrowed down hint sentence could be “do you need a mobile phone with a bluetooth feature?”, and a narrowed down confirmation hint sentence could be “yes/no/don't-care”. The grammar of the hint sentence, voice recognition, and understanding are based on the abovementioned sentences. A better criterion of choices for widening up and narrowing down the inquiry range is defined to give the user suggestions in the step 308. The criterion could be (a) the wider the better, (b) the narrower the better, or (c) the closer to the half number of the former results the better. Take 20 results for example under the criterion (c). Regarding those 20 search results provided by the system, we add one more new choice in the current choice list, which is ranked in top of those choices ranked in a recommending order for amending the number of results to be closer to 10.

After completing configurations of all the domain knowledge, for a matter of efficiency, in step 309, where offline is conducted, the grammar database 105, the domain knowledge database 109, and the conflict information database 110 utilized by the voice recognizer 104 and the language understanding unit 106 are established in advance to establish the specific domain database 12, which cooperates with the domain independent inquiry dialogue system 11. Finally, the inquiry system of a new domain is therefore established.

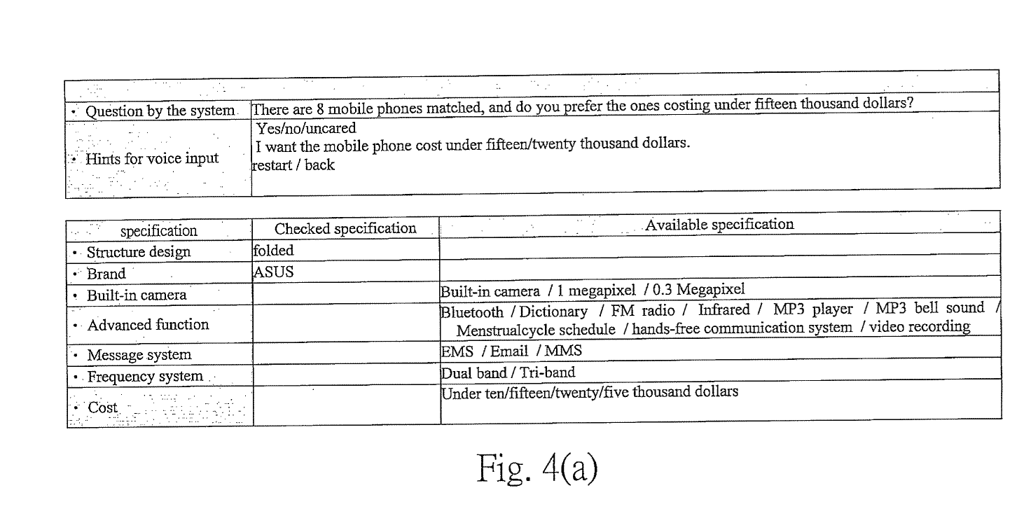

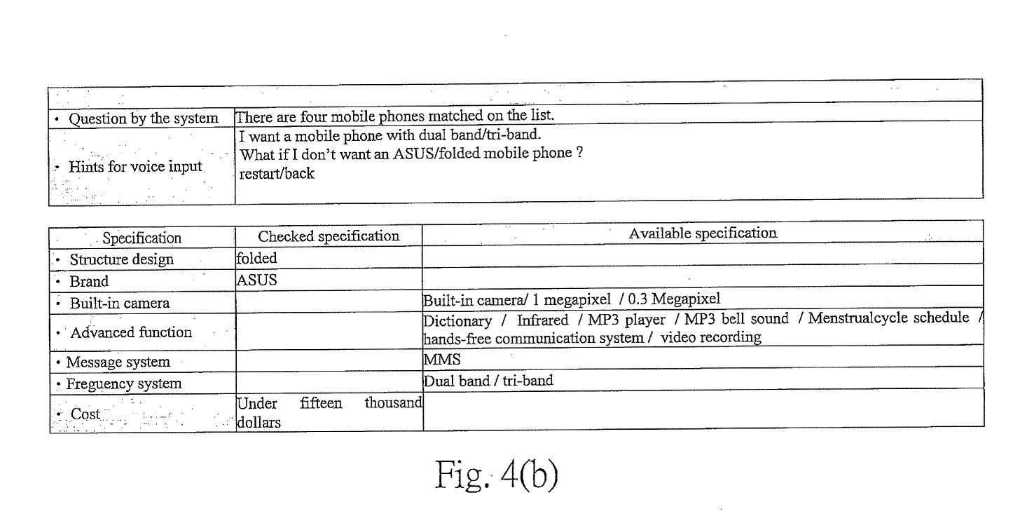

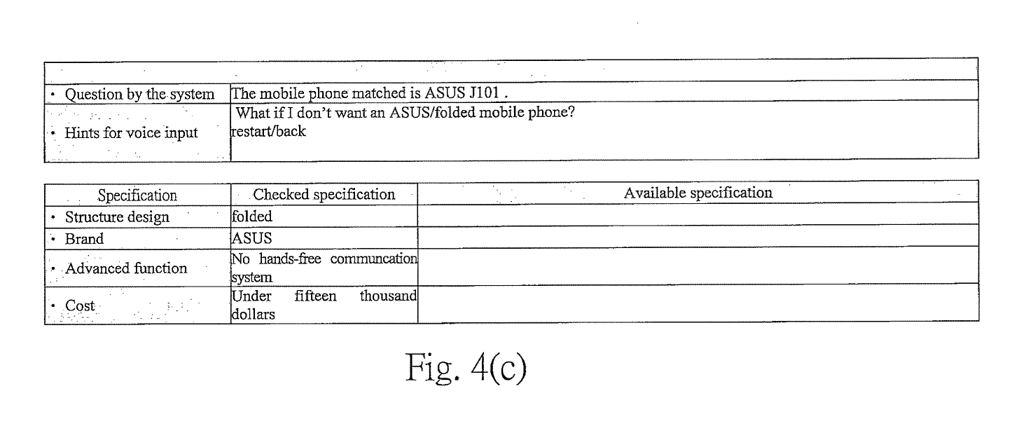

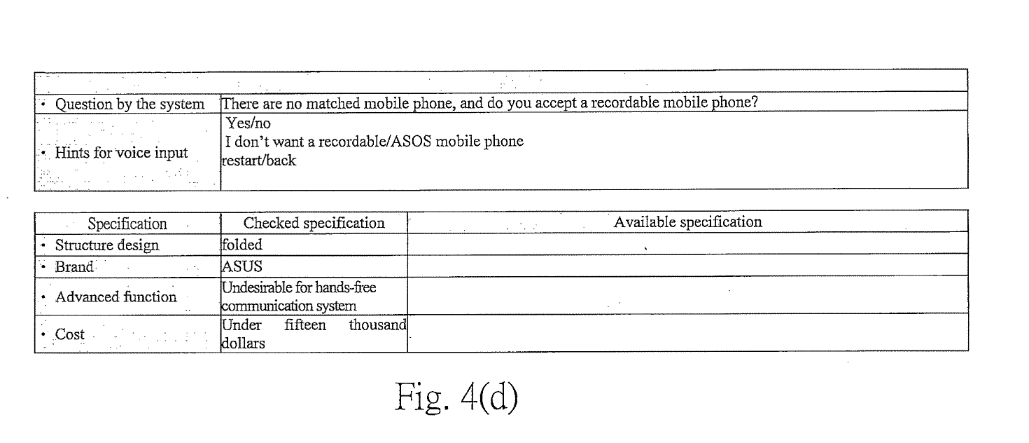

Please refer to FIGS. 4(a)-4(d), which are schematic diagrams showing the practical inquiry process according to a preferred embodiment of the present invention. In FIG. 4(a), the system responds with “There are 8 mobile phones matched, and do you prefer the ones under fifteen thousand dollars?”, and the hints for voice input are “yes/no/don't-care”, “I want the mobile phone under fifteen/twenty thousand dollars”, and “restart/back”. It is supposed that the user answers “I want the ones under fifteen thousand dollars”

In FIG. 4(b), the system responds with “There are four mobile phones matched on the list (not shown)”, and the hints for voice input is “I want a mobile phone with dual band/tri-band”, “What if I don't want an ASUS/folded mobile phone?”, and “restart/back”. It is supposed that the user answers, “What if I don't want a hands-free mobile phone?”.

In FIG. 4(c), the system responds with “The mobile phone matched is ASUS J 101 on the list (not shown)”, and the hints for voice input are “What if I don't want an ASUS/folded mobile phone?” and “restart/back”. It is supposed that the user answers, “I want a recordable mobile.”

In FIG. 4(d), the system responds with “There are no matched mobile phones, and do you accept a non-recordable mobile phone?”, and the hints for voice input are “yes/no”, “I don't want a recordable/ASUS mobile phone” and “restart/back”.

To summarize, the present invention proposes a method and system for voice recognition, wherein a hint sentence is displayed on the display to give the user an idea on what to say and three choice states are proposed for the user to inquire and confirm, thereby improving the drawbacks of the prior art. Thus, the present invention not only bears novelty and obviously progressive nature, but also bears the utility for the industry.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for recognizing a voice, comprising steps of:
(a) displaying a substitute choice and a hint sentence containing a suggested choice as a reference for a user;
(b) receiving the voice to be recognized from the user;
(c) conducting a search in a database to give a result according to the voice; and
(d) repeating steps (a)-(c) to narrow down a search range until a desirable result is obtained.

2. The method as claimed in claim 1, wherein the hint sentence and the substitute choice are displayed on a display.

3. The method as claimed in claim 1, wherein the step (a) further comprises a step of displaying a first choice state, a second choice state, and a third choice state.

4. The method as claimed in claim 3, wherein the first choice state is a state of “yes”.

5. The method as claimed in claim 3, wherein the second choice state is a state of “no”.

6. The method as claimed in claim 3, wherein the third choice state is a state of “don't-care”.

7. The method as claimed in claim 1, wherein the database is established by following steps of:
(a) preparing a domain database for a product;
(b) defining a plurality of choices relating to the product;
(c) tagging each of the plurality of choices with all possible descriptions;
(d) defining a classification and a hierarchy among the plurality of choices;
(e) defining a conflict relationship among the plurality of choices;
(f) defining a quantifier for the product;
(g) defining a specific hint sentence;
(h) defining a criterion for narrowing down and widening up an inquiring range; and
(i) establishing a grammar database, a domain knowledge database, and a conflict information database.

8. The method as claimed in claim 7, wherein the plurality of choices contain the suggested choices and the substitute choices.

9. The method as claimed in claim 1, wherein the database is a specific domain database.

10. The method as claimed in claim 1, wherein the step (d) further includes steps of repeating steps (a)-(c) to widen up the search range until the desirable result is obtained.

11. A voice recognizing system giving an inquiry result based on a voice input, comprising:
a specific domain database; and
an inquiry dialogue system, comprising:
a voice recognizer recognizing the voice input;
a language understanding unit connected to the voice recognizer and understanding the voice input to give a semantic result; and
an inquiry dialogue controller connected to the language understanding unit and conducting a dialogue control and an inquiry according to the semantic result to give a hint sentence and the inquiry result.

12. The system as claimed in claim 11, wherein the specific domain database comprises:
a grammar database storing a plurality of words and a plurality of grammars, thereby the voice recognizer and the language understanding unit connected thereto recognizing and analyzing the voice input;
a domain database connected to the inquiry dialogue controller and storing a plurality of data relating to a product;
a domain knowledge database connected to the inquiry dialogue controller and storing a domain knowledge relating to the product; and
a conflict information database connected to the inquiry dialogue controller and managing to store a conflict relationship among choices for the product.

13. The system as claimed in claim 12, wherein the inquiry result is derived from the plurality of data.

14. The system as claimed in claim 11, wherein a text-to-speech module is connected to the inquiry dialogue controller.

15. The system as claimed in claim 14, wherein a voice output device is connected to the text-to-speech module for giving a voice output.

16. The system as claimed in claim 11, wherein a voice input device is connected to the voice recognizer for receiving the voice input therewith.

17. The system as claimed in claim 16, wherein the voice input device is a microphone.

18. The system as claimed in claim 11, wherein a display is connected to the inquiry dialogue controller for displaying the hint sentence and the inquiry result.

19. A voice recognizing system giving an inquiry result based on a voice input, comprising:
an inquiry dialogue system; and
a specific domain database, comprising:
a grammar database storing a plurality of words and a plurality of grammars;
a domain database storing a plurality of data relating to a product;
a domain knowledge database storing a domain knowledge relating to the product; and
a conflict information database managing to store a conflict relationship among choices for the product.

20. A method for recognizing a voice for a user, comprising steps of:
(a) displaying a substitute choice, a choice state, and a hint sentence including at least a suggested choice as a reference for the user;
(b) receiving the voice to be recognized;
(c) conducting a search in a database according to the voice to give a result of the search; and
(d) repeating steps (a)-(c) to narrow down a search range until a desirable result of the search is acquired.

21. The method as claimed in claim 20, wherein the hint sentence, the substitute choice, and the choice state are displayed on a display.

22. The method as claimed in claim 20, wherein the choice state at least has a first choice state, a second choice state, and a third choice state.

23. The method as claimed in claim 22, wherein the first choice state is a state of “yes”.

24. The method as claimed in claim 22, wherein the second choice state is a state of “no”.

25. The method as claimed in claim 22, wherein the third choice state is a state of “don't-care”.

26. The method as claimed in claim 20, wherein the step (d) further includes repeating steps (a)-(c) to widen up the search range until the desirable result of the search is obtained.

27. A method for establishing a database in a specific domain, comprising steps of:
(a) preparing a domain database for a product;
(b) defining a plurality of choices relating to the product;
(c) defining a hint sentence;
(d) defining a criterion for changing an inquiring range for the product; and
(e) establishing a grammar database, a domain knowledge database, and a conflict information database.

28. The method as claimed in claim 27 further comprising a step of tagging each of the plurality of choices with all possible descriptions.

29. The method as claimed in claim 27 further comprising a step of defining a classification and a hierarchy for the plurality of choices.

30. The method as claimed in claim 27 further comprising a step of defining a conflict relation for each of the plurality of choices.

31. The method as claimed in claim 27 further comprising a step of defining a quantifier for the product.
